(19) United States
(12) Patent Application Publication
(10) Pub. No.: US 2026/0309849 A1
(43) Pub. Date: Oct. 8, 2026

(54) RECOGNITION OF LIGHT-SCATTERING ARTIFACTS IN LIDAR

(71) Applicant: Robert Bosch GmbH, Stuttgart (DE)

(72) Inventors: Chengxuan Fu, Ditzingen (DE); Joao Pedro Ribeiro, Rio Tinto, Porto (PT); Luciano Sousa, Braga (PT); Sebastien Lemetter, Leonberg (DE)

(21) Appl. No.: 19/484,956

(22) PCT Filed: May 15, 2024
(86) PCT No.: PCT/EP2024/063343

§ 371 Date: Jan. 28, 2026

(30) Foreign Application Priority Data
May 25, 2023 (DE) 10 2023 204 894.9

(51) Int. Cl. G01S 7/487; G01S 7/48; G01S 17/42; G01S 17/66

(52) U.S. Cl. CPC G01S 7/4876; G01S 7/4802; G01S 17/42; G01S 17/66

(57) ABSTRACT

Recognizing cross-talk-causing object (CTCO) objects at great distances, from which the objects do not lead to cross-talk (CT) or lead to negligible CT. The CTCO objects are temporally tracked. By comparing the dimensions of the objects with the previous timestamps, changes in the borders of the objects are recognized. The echoes which “grow” from the borders of the CTCO objects are then classified as CT echoes.

### FIELD

The present invention relates to a lidar unit for a vehicle, to a vehicle having a lidar unit and to a method for reducing erroneous measurements in a lidar unit.

### BACKGROUND INFORMATION

In the field of ADAS (Advanced Driving Assistance Systems) and AD (Autonomous Driving), a lidar sensor (Light Detection and Ranging) can measure the environment so that the environment can be represented by a 3D point cloud.

There are various types of lidar sensors using different technologies. They can differ in the way the environment is scanned. Here are some examples. Flash lidar operates like a camera, emitting laser beams in all directions and receiving reflections from all directions at once; on the other hand, there are lidars with rotating mirrors or micromechanically designed components (MEMS) for guiding the laser beams; or some lidars rotate the entire detector and the emitting units. They can also differ in how the reflected lights are received, e.g. with APD or SPAD detectors.

Thus, lidar systems emit laser light to scan the environment. The emitted laser light is reflected by objects in the environment and detected by the lidar systems. In this lidar system, the reflected laser light passes through a plurality of optical elements before impinging on a sensor for detecting the reflected laser light. Refraction and reflection can occur in the optical elements of the lidar unit, so that a portion of the reflected laser light is deflected from its original path and impinges on the lidar system sensor at a different location than intended. The lidar system derives a location of reflection of the emitted laser light in the vicinity of the lidar system from the location of detection on the sensor. Due to the detection of deflected portions of the reflected laser light, the lidar unit draws an incorrect conclusion that objects exist in the environment of the lidar system even though they do not. These are scattering artifacts. This will be explained in more detail in the following description with reference to the images shown in FIG. 3 to 5.

Scattering artifacts occur particularly with highly reflective objects, such as traffic signs, in the lidar environment and with particularly sensitive sensors, such as SPAD sensors. Scattering artifacts can obscure real objects or make objects appear larger than they actually are. Previous methods and systems for recognizing and removing light-scattering artifacts are based on post-processing the detected laser light. For such post-processing, a plurality of strong indicators are needed to recognize a scattering artifact.

One way of recognizing and minimizing such light-scattering artifacts is shown in Germany Patent Application No. DE 10 2022 206 316.3 (Related Art). This patent application is referred to in the following description, in particular in the description of FIGS. 1, 2, 6, 7 and 8.

### SUMMARY

Almost all lidar types exhibit the so-called cross-talk effect (CT), which is caused by very strong reflections from retroreflective surfaces such as traffic signs, license plates, cat's eye reflectors on the roadway, or reflective stripes on vehicles or pedestrians. This type of object is referred to as a CTCO (cross-talk-causing object).

In the illustration of a lidar sensor shown as FIG. 3, the elliptically marked region 301 can be seen, within which such CT-induced CTCO echoes are shown. The object within region 301 could, for example, be a traffic sign. The CTCO echoes can be seen in light gray in region 303; the CT echoes can be seen in region 302 (in dark gray). The other echoes are marked in white here. It can be seen how the highly reflective region 303 (CTCO object, here a highly reflective traffic sign) also leads to CT echoes in the regions 302 above and below the region 303.

The present invention includes recognizing CTCO objects at great distances, from which the objects do not lead to CT or lead to negligible CT. The CTCO objects are then temporally tracked. By comparing the dimensions of the objects with the previous timestamps, changes in the borders of the objects are recognized. The echoes which “grow” from the borders of the CTCO objects are then classified as CT echoes.

The present invention relates to a lidar unit for a vehicle.

According to an example embodiment of the present invention, the lidar unit comprises:
an emitting unit by means of which primary light is emitted into an environment of the lidar unit.
a receiving unit by means of which secondary light reflected by objects in the environment is detected.
an evaluation unit by means of which, cyclically,
   possible reflection points in the environment at which the primary light was reflected are ascertained from the detected secondary light,
   those portions of the detected secondary light that are assigned to the ascertained reflection points are identified as echo signals, and
   from the signal properties of the identified echo signals, a subset, referred to above as CTCO, is ascertained which represents an increased reflection at the assigned reflection points compared to the remainder of the echo signals.

The present invention includes that
the ascertained subset (CTCO) of the echo signals, i.e., the CTCO echoes, can be tracked over further cycles and
determining the subset (CTCO) of the echo signals in a cycle is carried out at least depending on the subset (CTCO) ascertained in a preceding cycle.

A major advantage of the present invention is that, with knowledge of the tracked CTCO object, the classification of CT echoes is also possible, even if the CTCO object is located outside the ascertained detection region (field of view, FoV) of the lidar sensor. This effect occurs if the CTCO object gets so close to the ego vehicle that it is no longer located within the vertical FoV of the lidar sensor.

In an advantageous embodiment of the present invention, it is provided that the possible reflection points at which the primary light was reflected is ascertained from the time of flight of the detected secondary light. Thus, distance measurement of the reflection points is carried out based on the time difference between the emission and reception of the light. This is known as the “time of flight” principle.

In a further advantageous embodiment of the present invention, it is provided that ascertaining the subset (CTCO) is carried out in such a way that the intensity and/or the pulse width of the echo signals are evaluated as signal properties of the identified echo signals. This means that when receiving point cloud data from the lidar, each echo is classified based on its measured signal characteristics such as intensity or pulse width, as to whether it is a CTCO echo. This is carried out until the entire point cloud has been received. This embodiment, i.e., the analysis during the reception phase of the entire point cloud, has the advantage that the total runtime can be reduced.

Furthermore, it can be provided that the temporal tracking of the ascertained subset (CTCO) of the echo signals is carried out by means of a conventional Kalman filter. After tracking the CTCOs over at least two measurement/evaluation cycles, e.g. with the aid of a Kalman filter, the newly measured CTCO (in the current cycle) is used to either generate new CTCOs or update existing tracks. Specifically, this means:

Ascertaining the subset (CTCOᵢ) of the echo signals in a cycle (i) is carried out at least depending on the subset (CTCOᵢ₋₁) ascertained in a preceding cycle (i−1) in such a way that the subset (CTCOᵢ) ascertained in the current cycle is added to the subset (CTCOᵢ₋₁) ascertained in the preceding cycle.

Furthermore, according to an example embodiment of the present invention, it can be provided that determining the subset (CTCOᵢ) of the echo signals in a cycle (i) is carried out at least depending on the subset (CTCOᵢ₋₁) ascertained in a preceding cycle (i−1) in such a way that the subset (CTCOᵢ₋₁) already ascertained in a preceding cycle (i−1) is updated by the subset (CTCOᵢ) ascertained in the current cycle.

According to an example embodiment of the present invention, it is particularly advantageous if determining the subset (CTCOᵢ) of the echo signals in the current cycle (i) is carried out at least depending on the spatial proximity of the reflection points that belong to the subset (CTCOᵢ₋₁) ascertained in a preceding cycle (i−1). This means that the current CTCOs are created by clustering neighboring CTCO echoes.

The tracked CTCOs are used to identify neighboring echoes around those CTCOs that are classified as CT candidate echoes. In a final step, CT detection algorithms, e.g., exponential decay algorithm or geometric feature-based algorithms, are then applied to the CT candidate echoes. This step is necessary in order to distinguish between real CT echoes and other real object echoes that may be located near the CTCO. That is,
the echo signals ascertained in the current cycle (i) that were ascertained by the spatial proximity of the current reflection points to the reflection points ascertained in a preceding cycle (i−1) are identified as further possible candidates for the current subset (CTCOᵢ), and
the echo signals identified as possible candidates are, after further evaluations such as
   the evaluation of an exponential decay of the intensity of the echo signals and/or
   the evaluation of a geometric distribution, added to the subset (CTCOᵢ) determined in the current cycle (i).

The present invention also relates to a vehicle that comprises a lidar unit according to the present invention.

Furthermore, the present invention comprises a method for reducing erroneous measurements of a lidar unit. According to an example embodiment of the present invention, the method in particular having a lidar unit according to the present invention, the method comprises the following steps:
emitting a primary laser light into a lidar environment,
receiving and detecting secondary laser light that has been reflected by objects in the lidar environment,
ascertaining possible reflection points in the environment at which the primary light was reflected,
identifying as echo signals those portions of the detected secondary light that are assigned to the ascertained reflection points,
ascertaining a subset (CTCO) of the identified echo signals from the signal properties of the identified echo signals, wherein the ascertained subset (CTCO) of the echo signals represents an increased reflection at the assigned reflection points compared to the remainder of the echo signals,
temporally tracking the ascertained subset (CTCO) of echo signals across further cycles,
determining the subset (CTCO) of echo signals in a cycle, at least depending on the subset (CTCO) ascertained in a preceding cycle.

Further advantageous embodiments of the present invention are disclosed herein.

### BRIEF DESCRIPTION OF THE DRAWINGS

Exemplary embodiments of the present invention are described in detail below with reference to the figures.

FIG. 1 is a schematic view of a vehicle having a lidar unit according to the aforementioned related art Germany Patent Application No. DE 10 2022 206 316.3.

FIG. 2 is a schematic view of a lidar unit according to the aforementioned related art Germany Patent Application No. DE 10 2022 206 316.3.

FIG. 3 to 5 show images of a lidar unit in order to illustrate the present invention.

FIG. 6 is a schematic view of a two-dimensional section of a three-dimensional point cloud according to the aforementioned related art Germany Patent Application No. DE 10 2022 206 316.3.

FIG. 7 is a schematic view of a list of collinearity values of erroneous measurement points according to the aforementioned related art Germany Patent Application No. DE 10 2022 206 316.3.

FIG. 8 is a schematic view of a two-dimensional section of a three-dimensional point cloud, according to the aforementioned related art Germany Patent Application No. DE 10 2022 206 316.3, in which all measurement points exhibit a collinearity value of 0.9 or greater.

FIG. 9 shows a flow of the method of the present invention with reference to an exemplary embodiment.

### DETAILED DESCRIPTION OF EXAMPLE EMBODIMENTS

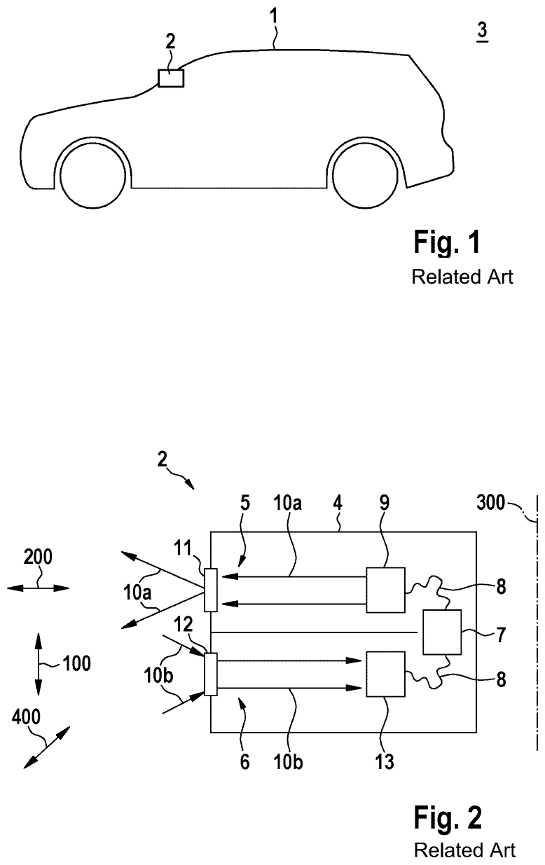

FIG. 1 is a schematic view of a vehicle 1 having a lidar unit 2 according to an exemplary embodiment of the present invention. In this exemplary embodiment, the lidar unit 2 is mounted at the front of the vehicle 1. However, the lidar unit 2 can be mounted at any location on vehicle 1. In particular, a plurality of lidar units 2 can also be mounted at different positions on the vehicle 1.

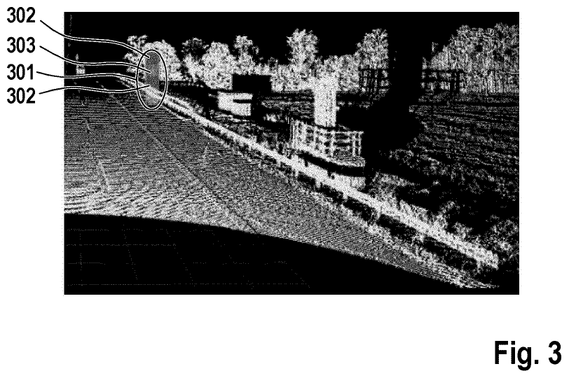

FIG. 2 is a schematic view of a lidar unit 2 according to an exemplary embodiment of the present invention. The lidar unit 2 comprises an emitting unit 5, a receiving unit 6 and an evaluation unit 7. The evaluation unit 7 is electrically connected in each case to the emitting unit 5 and the receiving unit 6 via an electrical connection 8, particularly for information exchange. In particular, the emitting unit 5, the receiving unit 6 and the evaluation unit 7 can be located in a lidar housing 4. However, it is also possible that the emitting unit 5, the receiving unit 6 and the evaluation unit 7 are each located in their own separate housing. The emitting unit 5 comprises a laser light source 9 that is designed to generate and transmit primary laser light 10a. Furthermore, the emitting unit 5 comprises a first optics unit 11 through which the primary laser light 10a exits the lidar housing 4 and is transmitted into a lidar environment 3. The transmitted primary laser light 10a is reflected by objects in the lidar environment 3 and transmitted back to the lidar unit 2 as secondary laser light 10b. The receiving unit 6 is designed to receive and detect the secondary laser light 10b. The receiving unit 6 comprises a second optics unit 12 through which the secondary laser light 10b enters the lidar housing 4. Furthermore, the receiving unit 6 comprises a sensor 13 that detects the received secondary laser light 10b.

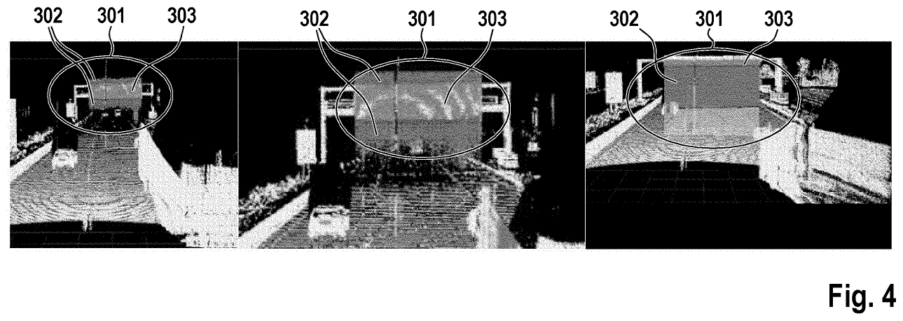

FIG. 3 was already described at the beginning.

As mentioned at the beginning, the core concept of this invention consists of recognizing CTCO objects at great distances, from which the objects do not lead to CT or lead to negligible CT. Said CTCO objects are then temporally tracked. By comparing the dimensions of the objects with the previous timestamps, changes in the borders of the objects are recognized. The echoes which “grow” from the borders of the CTCO objects are then classified as CT echoes.

The three illustrations in FIG. 4 show this increasing effect of CT echoes. The three lidar images arranged side by side in FIG. 4 show a sign bridge mounted over a road, which is marked with the ellipse 301. The ego vehicle, i.e. the vehicle having the lidar unit, approaches this sign bridge from left to right in the course of the three illustrations. The sign bridge 301 comprises a highly reflective surface in the region 303 (marked in light gray). This also results in CT echoes in the regions 302 (marked in dark gray) above and below the highly reflective surface 303. While, in the two left-hand illustrations, this is still completely captured by the lidar of the vehicle, in the right-hand illustration, the vehicle is already so close to the sign bridge that the highly reflective surface 303 can only be recognized as a small section, but still causes clear CT echoes in the lower portion 302.

In the illustration shown in FIG. 5, the vehicle has approached the sign bridge so closely that the highly reflective surface 303 (FIG. 4) is no longer captured by the lidar sensor (303 is outside the FOV), but the distinct CT echoes 302 emanating from this surface 303 (FIG. 4) are still captured by the lidar sensor as erroneous signals. Thus, a major advantage of taking CT echoes from preceding capture cycles into account according to the present invention is that, with knowledge of the tracked CTCO object, the classification of CT echoes (302) is also possible, even if the CTCO object (303) is located outside the FoV, as shown in FIG. 5. This effect occurs if the CTCO (in this case a signal bridge) comes too close to the ego vehicle and is no longer within the vertical field of view of the sensor.

With reference to following description of FIGS. 2, 6, 7, and 8, an exemplary recognition of light-scattering artifacts in lidar measurement point clouds will be illustrated on the basis of an analysis of the local geometry of the point clouds of light points. Reference is made here, in terms of content, to the unpublished German patent application DE102022206316.3.

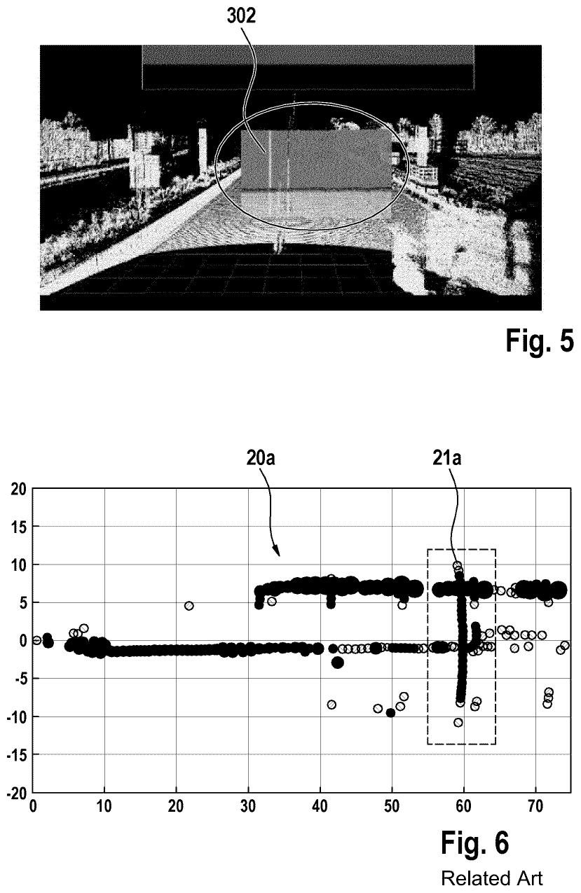

The evaluation unit 7 (FIG. 2) is designed to ascertain the time of flight of the detected secondary laser light 10b. From the time of flight of the secondary laser light 10b, the evaluation unit 7 can ascertain the distance of a reflecting object to the lidar unit 2. Furthermore, the evaluation unit 7 is designed to evaluate the position of the reflection of the secondary laser light 10b, taking into account the time of flight in the lidar environment 3, and to store the evaluated position of the reflection of the secondary laser light 10b in the lidar environment 3 as a measurement point 20a in a three-dimensional point cloud. In addition, the evaluation unit 7 is designed to recognize measurement points 20a of the point cloud in a spherical arrangement 21a around the position of the receiving unit 6 in the point cloud as erroneous measurement points 20b and to remove the erroneous measurement points 20b, 21b from the stored point cloud. An explanation of this process with reference to FIG. 6 to 8 can be found below. As previously explained, the deflection and reflection of the secondary laser light 10b as it passes through the second optics unit 10b and possible further optics units in the receiving unit 6 results in a spherical arrangement of the erroneous measurement points 20b, 21b created by this deflection, the center of which arrangement is the receiving unit 6. Since a random arrangement of objects in the lidar environment 3 in the aforementioned arrangement is unlikely, the classification of measurement points 20a, 21a, whose position is part of a spherical arrangement 21a, as erroneous measurement points 21b is a permissible assumption. This allows the erroneous measurement points 20b, 21b to be reliably recognized and removed with minimal effort compared to correct measurement points. This improves reliability and reduces the size of the point cloud. For downstream analyses of the point cloud, for example by assistance systems of the vehicle 1, this results in a time saving and an increase in the reliability of these assistance systems.

Preferably, the position of the receiving unit 6 is located at the coordinate origin of the point cloud and determining the erroneous measurement points 20b, 21b by the evaluation unit is carried out by comparing the coordinate vector of the measurement points 20a, 21a with the normal vectors of the measurement points 20a, 21a. Ascertaining normal vectors is a common process in lidar systems and therefore represents no or almost no additional effort for the evaluation unit 7. Since the measurement points 20a, 21a correspond to the reflections at an object in the environment and thus represent a surface, the normal vector of the measurement points 20a, 21a is the normal vector of the represented surface at the corresponding measurement point 20a, 21a. Positioning the receiving unit 6 at the coordinate origin of the point cloud simplifies the determination of the erroneous measurement points 20b, 21b by the evaluation unit 7, since no offset of the receiving unit 6 to the coordinate origin of the point cloud needs to be taken into account.

A possible point cloud, as initially created by the evaluation unit 7, is shown in FIG. 6. This is a schematic view of a two-dimensional section of a three-dimensional point cloud according to an exemplary embodiment of the present invention. On the abscissa of the diagram, a distance or depth from the receiving unit is plotted in meters. On the ordinate of the diagram, a height difference relative to the receiving unit 6 is plotted in meters. A plot of the deviation of the measurement points 20a, 21a from the receiving unit 6 along a further axis that would be orthogonal to the abscissa is omitted for reasons of clarity. Plotted in the two-dimensional diagram are measurement points 20a, 21a. These include both correct measurement points, which indicate an actual position of a reflection of the secondary laser light 10b, and erroneous measurement points 20b, 21b. Enclosed within a frame is a spherical arrangement 21b that arches around the coordinate origin.

The evaluation unit 7 calculates a collinearity value for each measurement point 20a, 21a by comparing the normal vectors of the measurement points 20a, 21a with the coordinate vectors of the measurement points 20a, 21a. The collinearity value is a measure of the correspondence between the normal vector and the coordinate vector of the measurement points 20a, 21a and thus a measure of whether a measurement point 20a, 21a belongs to a spherical arrangement. By specifying a measure, it is possible within a value range of that measure, here the collinearity value, to determine that a measurement point 2a, 21a is to be regarded as belonging to a spherical arrangement. This enables inaccuracies to be taken into account by identifying measurement points 20a, 21a, whose normal vector and coordinate vector correspond sufficiently closely to one another, as erroneous measurement points 20b, 21b. Thus, measurement points 20a, 21a, whose collinearity value is above a threshold value, e.g. above a threshold value of 0.75, can be identified as erroneous measurement points 20b, 21b by the evaluation unit 7. The evaluation unit 7 can remove the identified erroneous measurement points 20b, 21b from the point cloud.

The collinearity value can be calculated from the negated product of the normalized normal vector of the measurement point 20a, 21a and from the normalized coordinate vector of the measurement point 20a, 21a. By normalizing the normal vector and the coordinate vector, the collinearity value assumes a value range from −1 to 1, irrespective of the actual length of the vectors. This enables the direct comparison of the collinearity values of different measurement points 20a, 21a and the evaluation of the collinearity value of the measurement points 20a, 21a in view of a threshold value, as explained in the previous section. If a measurement point 20a, 21a belongs to a spherical arrangement, the normal vector of the measurement point 20a, 21a points toward the coordinate origin. When calculating the product of the normal vector and the coordinate vector, a negative product results. In order to obtain a positive collinearity value when a measurement point 20a, 21a belongs to a spherical arrangement, the product of the normal vector and the coordinate vector must be negated.

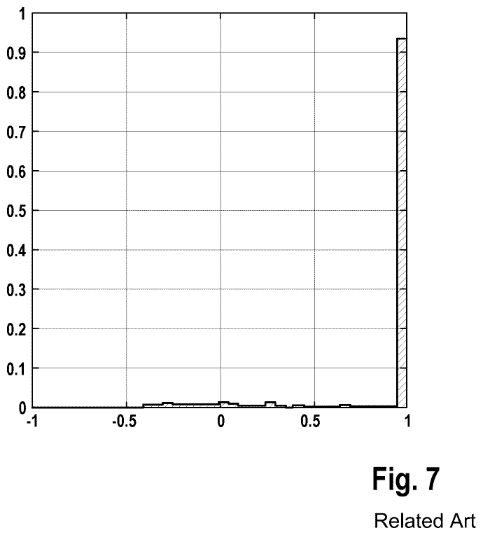

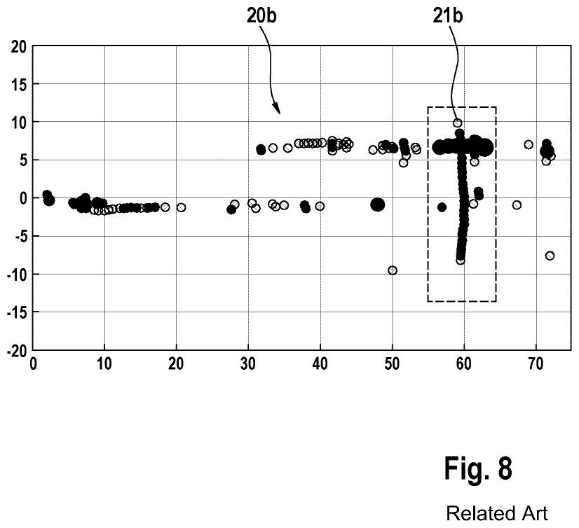

If this calculation of the collinearity value is carried out for all measurement points 20a, 21a of FIG. 6 and the collinearity values of the known erroneous measurement points are considered, one arrives at FIG. 7. This is a schematic view of a listing of collinearity values of the known erroneous measurement points according to an embodiment of the present invention. On the abscissa of the diagram, a collinearity value in the range from −1 to 1 is plotted. On the ordinate of the diagram, the normalized listing in the range from 0 to 1 is plotted. As can be seen from the diagram, over 90% of the known erroneous measurement points exhibit a collinearity value of 0.9 or greater. Only a small proportion, less than 10%, of the known erroneous measurement points exhibit a collinearity value of less than 0.9. If the evaluation unit 7 now operates with a threshold value of 0.9, only 10% of all known erroneous measurement points would not be recognized, and, when one of the above-described exemplary embodiments is carried out, would not be removed from the point cloud. If such a calculation according to one of the above-described exemplary embodiments is performed in the evaluation unit 7 on the point cloud 20a shown in FIG. 6 and a threshold value of 0.9 is determined, the erroneous measurement points 20b, 21b recognized are obtained as shown in FIG. 8.

FIG. 8 is one again a schematic view of the same two-dimensional section of the three-dimensional point cloud, according to an exemplary embodiment of the present invention, as in FIG. 6. The abscissa of the diagram indicates the distance of measurement points 20b, 21b from the receiving unit 6 in meters. The ordinate of the diagram indicates a height difference of the measurement points 20b, 21b with reference to the receiving unit 6 in meters. The measurement points 20b and 21b shown are only measurement points 20 a and 21 a whose collinearity value is 0.9 or greater. Among the recognized erroneous measurement points 20b, 21b is also the spherical arrangement 21b previously located within the frame in FIG. 4. If these recognized erroneous measurement points 20b, 21b are removed from FIG. 6, the number of measurement points 20a, 21a remaining in FIG. 6 is considerably reduced. At the same time, fewer than 10% of all known erroneous locations would remain in the point cloud in FIG. 6.

In a further exemplary embodiment, the evaluation unit 7 is designed to transmit the point cloud corrected by the erroneous measurement points 20b, 21b to an external unit or to provide the point cloud to the external unit, so that the external unit can query the point cloud. This allows the point cloud to be passed on to assistance systems for further analysis, as mentioned above.

As shown in FIG. 2, the primary laser light 10a can comprise an extent in a first spatial direction 100 and is emitted by the emitting unit 7 in a second spatial direction 200. Here, the first spatial direction 100 does not correspond to the second spatial direction 200. In particular, the second spatial direction 200 is aligned orthogonally to the first spatial direction 100. If the first spatial direction 100 and the second spatial direction 200 are orthogonal to one another, a maximum vector of the environment is illuminated with primary laser light 10a from the emitting unit 5. Furthermore, the lidar unit 2 can rotate about a rotation axis 300, wherein the rotation axis 300 does not correspond to the second spatial direction 200. In particular, the rotation axis 300 can be parallel to the first spatial direction 100, so that the primary laser light 10a can be pivoted in a third spatial direction 400. This enables the largest possible area in the lidar environment 3 to be covered by pivoting the primary laser light 10a.

Accordingly, the receiving unit 6 is designed to receive and detect secondary laser light 10b having an extent in a first spatial direction 100. Furthermore, the detected secondary laser light 10b is entered and stored in a plurality of individual measurement points in the point cloud according to one of the above-described exemplary embodiments.

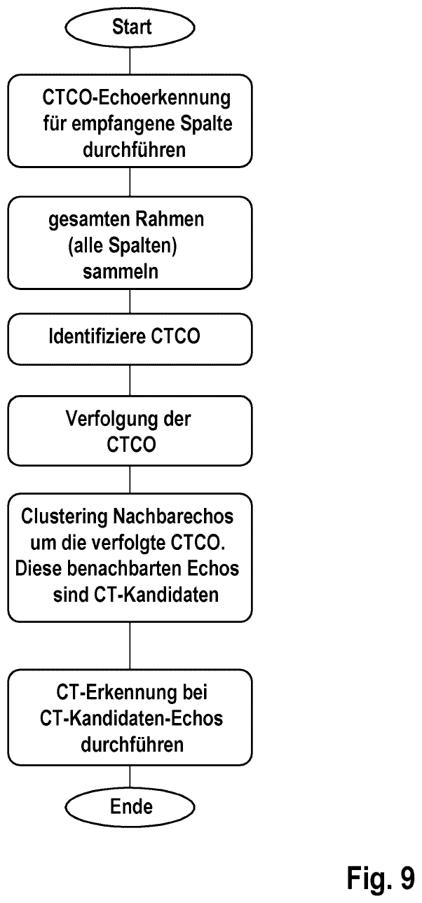

With reference to FIG. 9, an exemplary embodiment of the method according to the present invention will now be described:

The algorithm has the following steps and is performed cyclically, in each case beginning with the start step and ending with the end step:

### Step 1:

When receiving the point cloud data from the lidar sensor, each echo is classified based on its measured signal characteristics such as intensity or pulse width, as to whether it is a CTCO echo. Step 1 is executed until the entire point cloud has been received. Performing step 1 during the reception phase of the entire point cloud has the advantage that the total runtime can be reduced.

### Step 2:

CTCO echoes, i.e., echoes from objects causing cross talk/CT echoes, are created by clustering (step 2) neighboring CTCO echoes.

### Step 3:

Here, one or more CTCOs are identified based on the accumulated (cluster) echoes.

### Step 4:

Subsequently, in this step important to the present invention, these CTCOs are tracked, e.g. by using a Kalman filter, where newly measured CTCOs are used either to generate new CTCOs or to update existing tracks.

### Step 5:

The tracked CTCO(s) are used to identify neighboring echoes around those CTCOs that are classified as CT candidate echoes.

### Step 6:

In the final step, CT detection algorithms, e.g., exponential decay algorithm or geometric feature-based algorithms, are applied to the CT candidate echoes. This step is necessary in order to distinguish between real CT echoes and other real object echoes that may be located near the CTCO, for example when a real car happens to be driving under the sign bridge.

1-10. (canceled)

11. A lidar unit for a vehicle, the lidar unit comprising:
an emitting unit using which primary light is emitted into an environment of the lidar unit;
a receiving unit using which secondary light reflected by objects in the environment is detected;
an evaluation unit, using which, cyclically:
possible reflection points in the environment at which the primary light was reflected are ascertained from the detected secondary light,
those portions of the detected secondary light that are assigned to the ascertained reflection points are identified as echo signals, and
from the signal properties of the identified echo signals, a subset of the echo signals is ascertained which represents an increased reflection at the assigned reflection points compared to a remainder of the echo signals;
wherein:
the ascertained subset of the echo signals is temporally tracked over further cycles, and
the ascertaining of the subset of the echo signals in a cycle is carried out at least depending on a subset of echo signals ascertained in a preceding cycle.

12. The lidar unit according to claim 11, wherein the ascertaining the possible reflection points at which the primary light was reflected is derived from a time of flight of the detected secondary light.

13. The lidar unit according to claim 11, characterized in that ascertaining the subset of the echo signals is carried out in such a way that an intensity and/or a pulse width of the echo signals are evaluated as signal properties of the identified echo signals.

14. The lidar unit according to claim 11, wherein the temporal tracking of the ascertained subset of the echo signals is carried out using a Kalman filter.

15. The lidar unit according to claim 11, wherein the ascertaining of the subset of the echo signals in a cycle is carried out at least depending on the subset ascertained in a preceding cycle in such a way that the subset ascertained in a current cycle is added to the subset ascertained in the preceding cycle.

16. The lidar unit according to claim 11, wherein the determining of the subset of the echo signals in a cycle is carried out at least depending on the subset ascertained in the preceding cycle in such a way that the subset already ascertained in the preceding cycle is updated by a currently ascertained subset.

17. The lidar unit according to claim 11, wherein the determining of the subset of the echo signals in a current cycle is carried out at least depending on a spatial proximity of the reflection points that belong to the subset ascertained in the previous cycle.

18. The lidar unit according to claim 17, wherein:
the echo signals ascertained in the current cycle that were ascertained by the spatial proximity of current reflection points to the reflection points ascertained in a preceding cycle are identified as further possible candidates for a current subset of the echo signals, and
the echo signals identified as possible candidates are, after further evaluations including an evaluation of an exponential decrease in an intensity of the echo signals and/or an evaluation of geometric distribution, added to the subset of echo signals determined in the current cycle.

19. A vehicle, comprising:
a lidar unit, including:
an emitting unit using which primary light is emitted into an environment of the lidar unit;
a receiving unit using which secondary light reflected by objects in the environment is detected;
an evaluation unit, using which, cyclically:
possible reflection points in the environment at which the primary light was reflected are ascertained from the detected secondary light,
those portions of the detected secondary light that are assigned to the ascertained reflection points are identified as echo signals, and
from the signal properties of the identified echo signals, a subset of the echo signals is ascertained which represents an increased reflection at the assigned reflection points compared to a remainder of the echo signals;
wherein:
the ascertained subset of the echo signals is temporally tracked over further cycles, and
the ascertaining of the subset of the echo signals in a cycle is carried out at least depending on a subset of echo signals ascertained in a preceding cycle

20. A method for reducing erroneous measurements of a lidar unit, comprising the following steps:
emitting a primary laser light into a lidar environment;
receiving and detecting a secondary laser light that has been reflected by objects in the lidar environment;
ascertaining possible reflection points in the environment at which the primary light was reflected;
identifying as echo signals those portions of the detected secondary light that are assigned to the ascertained reflection points;
ascertaining a subset of the identified echo signals from the signal properties of the identified echo signals, wherein the ascertained subset of the echo signals represents an increased reflection at the assigned reflection points compared to a remainder of the echo signals;
temporally tracking the ascertained subset of echo signals across further cycles,
determining the subset of echo signals in a cycle, at least depending on the subset ascertained in a preceding cycle.
